(19) United States
(12) Patent Application Publication
(10) Pub. No.: US 2007/0294944 A1
(43) Pub. Date: Dec. 27, 2007

(54) Child Safety Barrier with a Gate

(76) Inventor: Henrik L. Pedersen, Sorring (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/660,760

(22) PCT Filed: Aug. 4, 2005
(86) PCT No.: PCT/DK05/00517

§ 371 Date: May 8, 2007

(30) Foreign Application Priority Data
Aug. 25, 2004 (DK) BA 2004 00223

(51) Int. Cl. E06B 9/04

(52) U.S. Cl. 49/50

(57) ABSTRACT

A child safety barrier, which has an upper and a lower cross member (2,3) between which a plurality of vertical lattice bars (4) are secured, is intended to be fixed in an opening. The child safety barrier is provided with two upper and two lower hinges which are rotatably connected with the child safety barrier. At least one of the two upper hinges is composed of two screw parts (19, 20) which are connected via a connecting pin (18). One of the screw parts (20) is provided with a hole with a toothing (24) which is capable of engaging one or more teeth on the connecting pin (18). Hereby, the hinges may be secured in openings against walls which are oriented with their faces which need not have a well-defined direction relative to the surface of the child safety barrier, and such that a hole (29) in the connecting pin (18) may be fixed relative to a locking pawl (28) which may be arranged in a handle on the child safety barrier.

The invention relates to a child safety barrier with a gate, said gate being formed by a horizontal upper cross member and a horizontal lower cross member between which a plurality of lattice bars are secured, said gate being mounted in an opening by means of hinges which are secured at the corners of the child safety barrier.

Child safety barriers adapted to be mounted in an opening are known e.g. from EP 0 900 316. This known barrier is constructed such that it may be fixed in an opening by means of pressure devices. A handle is provided at the left corner of the barrier, which, when being operated, is adapted to unlock the barrier and subsequently lift it at one side so that the barrier may be opened and pivoted out of the opening. The child safety barrier is particularly adapted to travelling purposes, where it may be mounted in an easy manner in an opening and be removed from it again.

Known are also barriers which are intended for permanent use, e.g. in children's rooms. These barriers, which are generally mounted by means of hinges which are screwed into a wall, must sometimes be adapted to the wall defining the opening. Most commonly, either the screw holes of the hinges are placed in a direction which is parallel with the plane of the barrier, or the screw holes are perpendicular to the plane of the barrier, which requires that the barriers are manufactured with individual hinges.

Accordingly, an object of the invention is to provide a child safety barrier which may be mounted permanently in an opening, and such that use of individual brackets adapted to the wall boundaries of a given opening are avoided to a great extent.

The object of the invention is achieved by a child safety barrier of the type defined in the introductory portion of claim 1, which is characterized in that the hinges are rotatably connected with the child safety barrier about an axis which is parallel with the vertical lattice bars.

When, as stated in claim 2, the upper hinges consist of two screw parts which are connected with each other via a connecting pin (18, 22), and the screw parts are movable relative to the connecting pin, it is possible to maintain the position of the connecting pin relative to the plane of the barrier, which is an advantage if the connecting pin is provided with a hole for receiving a locking pawl.

When, as stated in claim 3, the screw parts of at least one of the two upper hinges are formed with a hole with a toothing which is adapted to engage at least one tooth on the connecting pin, it is possible to maintain the connecting pin in predetermined angular positions relative to the screw part.

To additionally ensure that a child cannot open the barrier, it is an advantage if, as stated in claim 4, at least one of the connecting pins extends through a hole in a connecting part which is arranged in extension of a profile, and that the connecting pin is biased by means of a spring against the connecting part.

To achieve additional protection against unintentional opening of the barrier according to the invention, it is an advantage if, as stated in claim 5, one of the upper hinges is provided with a double lock, where one lock is configured as a horizontal movable pawl which is movable into or out of a hole in the connecting pin, while the other lock is configured as two adjoining faces on the screw part and the profile.

Hereby, several operations have to be performed in order to open the barrier, viz.
activation of the movable pawl,
lifting of the barrier so that the two adjoining faces are released from each other, where the lifting must take place with a certain force against a spring force.

Finally, it is advantageous if, as stated in claim 6, the profiles are secured displaceably in a horizontal direction relative to the upper and the lower cross members, said profiles being formed with a slot in which a pin on a vertical lattice bar may be displaced, and the profile has a horizontally extending cut-out in which a screw, which is adapted to be screwed into an upper or a lower cross member, fixes the profiles to the upper or the lower cross member. Hereby, the child safety barrier may be adapted to openings of different widths merely by displacing the profiles relative to the upper and lower cross members.

The invention will now be explained more fully with reference to the drawing, in which

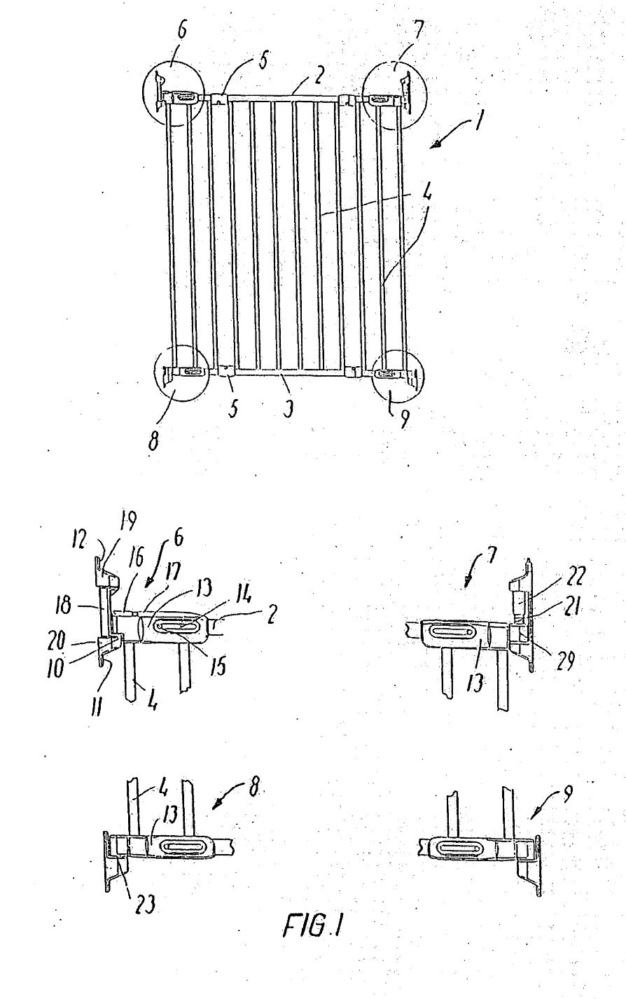

FIG. 1 shows a child safety barrier according to the invention with hinges shown in a first position, and the four hinges in an enlarged section at the bottom of the figure,

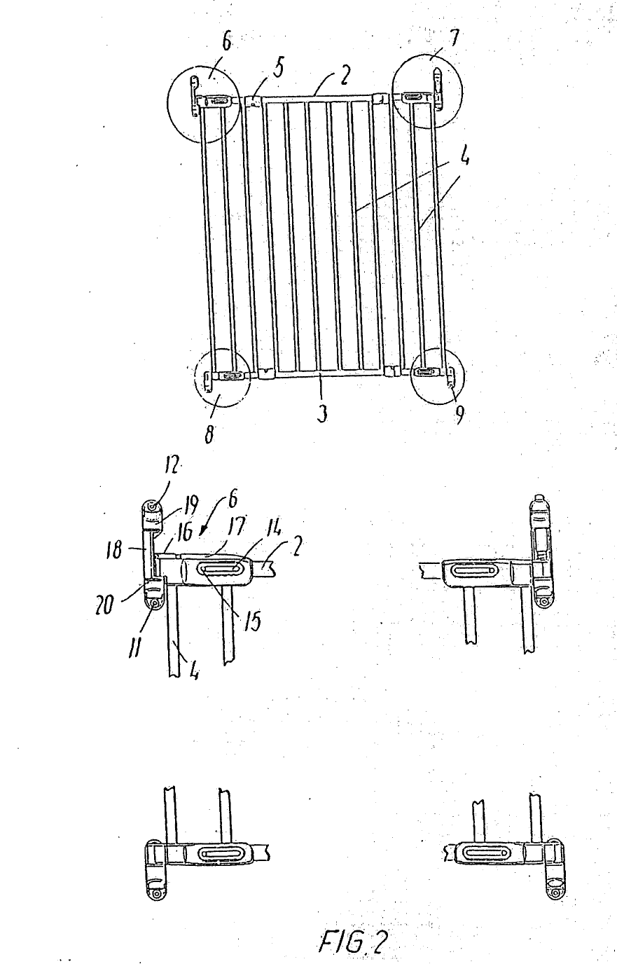

FIG. 2 shows the child safety barrier of FIG. 1 with the hinges shown in a second position, and likewise the four hinges shown in an enlarged section at the bottom of the figure,

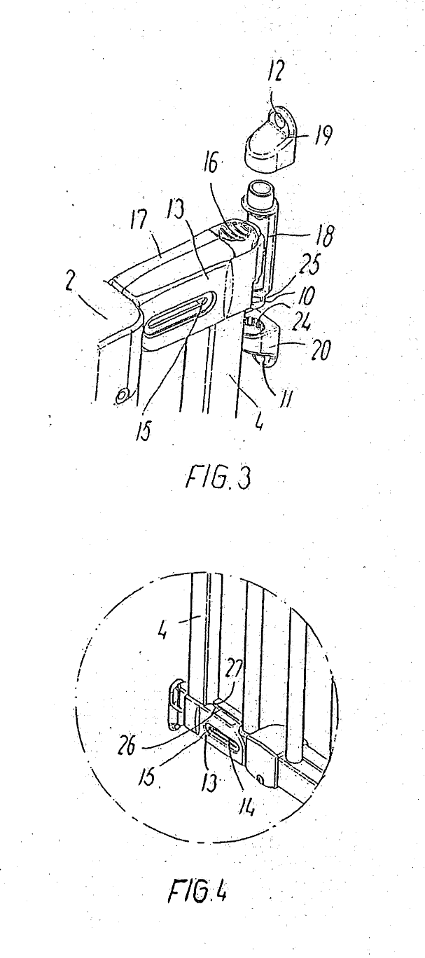

FIG. 3 shows the structure of the hinge with a lock at the upper left corner of the child safety barrier,

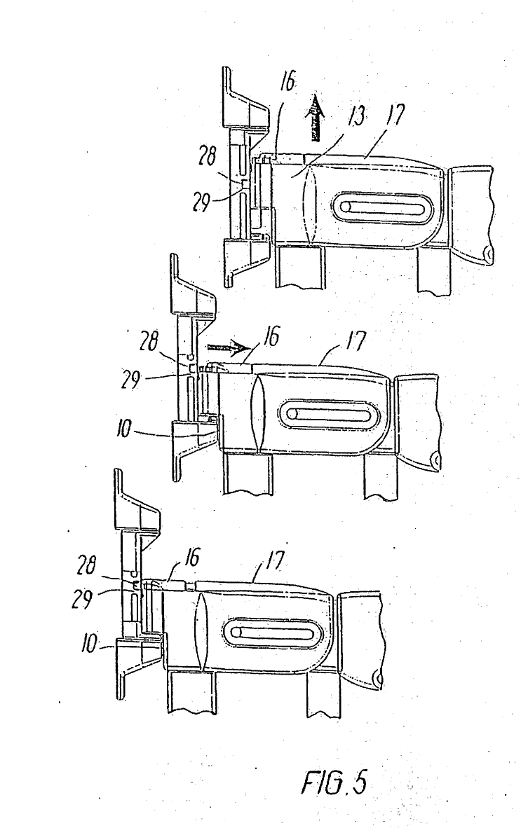

FIG. 4 shows the structure of the hinge at the lower left corner of the child safety barrier, while

FIG. 5 shows how the bracket in FIG. 4 is used in various working positions.

In the figures, the numeral 1 designates a child safety barrier according to the invention in its entirety.

As will be seen, the child safety barrier consists of an upper cross member 2 and a lower cross member 3 which are connected with each other by means of a plurality of vertical lattice bars 4.

Connecting brackets 5 are shown on the upper and lower cross members, allowing barriers of various lengths to be inserted. Since these connecting brackets are without importance to the invention, they will not be described more fully here.

The numeral 6 designates an upper hinge member with a lock which, as will be seen, is positioned at the left corner of the barrier.

The numeral 7 designates a hinge which is disposed at an upper right corner, while the numerals 8 and 9 designate lower hinges which are disposed at the left corner and the right corner, respectively.

The four hinges are shown on an enlarged scale at the bottom of FIG. 1.

The upper left hinge 6 with a lock, cf. also FIG. 4, consists of two screw parts 19, 20, which each have a screw hole 11, 12. These screw parts are connected with each other via a connecting pin 18, which is formed with a hole 29 for receiving a locking pawl 28, which is displaceable out of or into the hole 29 via an activation mechanism 16 provided in a profile 13. This activation mechanism is given a horizontal movement and slides on the profile 13, so that it slides into or out of a locking housing 17.

As will additionally be seen in FIG. 3, the screw part 20 is formed with a hole with a toothing 24 which cooperates with one or more teeth 25 on the connecting pin 18. Although only threads on the screw part 20 are shown, nothing prevents the other screw parts from being configured with a toothing in a corresponding manner, although it is not strictly necessary.

Moreover, it will be seen in particular in FIG. 1 and FIG. 4 that the profile 13 has a channel 14 on one side face and a slot 26 on its upper surface in which a pin 27 on a vertical lattice bar 4 may slide.

The lower cross member (and also the upper one) is formed with a screw hole 15 at the channel 14 which is intended to clamp the profile 13 firmly relative to the upper or the lower cross member.

As will be seen in FIG. 1, the upper right bracket 7 is secured in extension of the profile 13 with a connecting part 29, which has a hole for receiving a connecting pin 22, which, at the bottom, has a section with a smaller diameter surrounded by a spring 21, which presses downwards on the upper part of the connecting pin 22 and the connecting part 29 and thereby on the profile 13 and the entire barrier 1.

Finally, it will be seen that the lower hinges are constructed more simply than the upper hinges, as they are just formed by a screw part with a screw hole, and such that the profile 13 may slide on a surface of the screw part without any form of locking.

It will now be explained how the child safety barrier is mounted and operated.

When the barrier is to be mounted in an opening, the lower screw parts 20 of the upper brackets 6, 7 are screwed in. Also the screw part of the lower brackets is screwed in. Then, the connecting pin 18 is mounted in the screw part 20 so that the hole 29 in it is present at the locking pawl 28, following which the upper screw part 19 on the upper left bracket is screwed in.

The barrier itself is now positioned in the right hinges, and the screw part of the upper right hinge is secured to the connecting part 22 with the spring 21, following which the barrier is secured rotatably in the opening.

The width of the barrier is adjusted by displacing the brackets 13 in the upper and lower cross members, which are secured by screws in the screw holes 15 in the upper and lower cross members. Then, the gate is lifted upwards against the spring force, so that the profile 13 at the left lower corner may engage the screw part of the associated hinge. Finally, the barrier is locked by movement of the activating mechanism 16 to the left.

As will be seen, the daily operation of the child safety barrier takes place in that the activation mechanism with the pawl 18 is moved from a position shown at the bottom of FIG. 5 to the right, as shown by the arrow in the centre of FIG. 5, following which the child safety barrier is lifted, as shown by the arrow at the top of FIG. 5, and then the gate may be opened, as the adjoining faces 10 between the screw part 20 and the profile 13 are then disengaged from each other so that both locks of the double lock are released.

1. A child safety barrier (1) with a gate, said gate being formed by a horizontal upper cross member (2) and a horizontal lower cross member (3) between which a plurality of vertical lattice bars (4) are secured, said gate being mounted in an opening by means of two hinges secured at the left or right corner, said gate comprising two brackets secured in the corner opposite the corner having hinges, said hinges being rotatably connected with the child safety barrier about an axis which is parallel with the vertical lattice bars (4), wherein one of the hinges (6, 7) consists of two separate screw parts (19, 20) which are connected with each other via a connecting pin (18), and the two screw parts are individually movable relative to the connecting pin, and further both fastened to a wall boundary.

2. A child safety barrier according to claim 1, wherein one of the brackets consists of two separate screw parts (19, 20) which are connected with each other via a connecting pin (18, 22), and the screw parts are individually movable relative to the connecting pin, and further both fastened to a wall boundary.

3. A child safety barrier according to claim 2, wherein one of the screw parts (19, 20) of the hinges or brackets is formed with a hole with a toothing (24) which is adapted to engage at least one tooth on the connecting pin (18).

4. A child safety barrier according to claim 3, wherein the connecting pin (22) extends through a hole in a connecting part which is arranged in extension of a profile (13), and the connecting pin is biased by means of a spring (21) against the connecting part.

5. A child safety barrier according to claim 1, wherein the bracket is provided with a double lock, where the lock is configured as a horizontal movable pawl (28) which is movable into or out of a hole (29) in the connecting pin (18) of the bracket, while another lock in the hinge is configured as two adjoining faces (10) on the screw part (20) and the profile (13).

6. A child safety barrier according to claim 1, wherein the profiles (13) are secured displaceably in a horizontal direction relative to the upper and lower cross members, said profiles being formed with a slot (26) in which a pin (27) on a vertical lattice bar may be displaced, and the profile has a horizontally extending cut-out in which a screw,.which is adapted to be screwed into an upper or a lower cross member, fixes the profiles to the upper or the lower cross member.
